(19) United States
(12) Patent Application Publication
(10) Pub. No.: US 2004/0026431 A1
(43) Pub. Date: Feb. 12, 2004

(54) Low weight high performance composite vessel and method of making same

(76) Inventor: Brian H. Jones, San Gabriel, CA (US)

Correspondence Address: ROBERT J. SCHAAP, Suite 188, 21241 Ventura Boulevard, Woodland Hills, CA, 91364, US

(21) Appl. No.: 10/051,242

(22) Filed: Jan. 18, 2002

(51) Int. Cl. F17C 1/06

(52) U.S. Cl. 220/588

(57) ABSTRACT

A light weight high performance vessel, e.g., tank and method of making same which is produced primarily from reinforced plastic composite materials. The vessel can be used for the containment of liquids or pressurized gases. The tank is comprised of an inner shell which is split to remove a mandrel on which it is formed and to install components in the inner shell. The inner shell pieces are then secured together by means of a joinder ring. An outer shell is then formed around and completely encapsulates the inner shell. There is also no need for the employment of an inner liner although one can be used.

### BACKGROUND OF THE INVENTION

1. Field of the Invention

This invention relates in general to certain new and useful improvements in lightweight pressure vessels and more particularly, to a lightweight pressure vessel which is formed primarily of composite materials, and a method of making same. An inner shell of the tank is formed and then separated into a plurality of sections and allowing for removal of a mandrel and installation of vessel components, and which sections are then secured together in a unique manner and provided with an outer load bearing shell, to thereby provide a lightweight high performance tank.

2. Brief Description of Related Art

Many modern storage vessels, such as pressure vessels, are frequently formed with inner liners for leakproof containment of fluids and particularly gases under pressure. An outer load-bearing shell is frequently constructed of composite material so as to provide the load bearing capacity and durability needed for a pressure vessel.

Pressure vessels find employment in a wide variety of applications including those where the vessel is used in ambient atmospheric conditions so that the vessel can withstand pressure induced forces. Pressure vessels of this type include those used for self-contained breathing equipment. Other examples include those used in spacecraft, launch vehicles and satellites. These vessels must also be constructed to withstand the rigors of the launch process and the sometimes hostile outer space environment.

As a result of these pressure induced forces imposed upon the pressure vessel, these pressure vessels usually include an inner liner, as aforesaid. However, the inner liner substantially increases the weight of the vessel, but provides little or no ability to receive any of the load on the vessel and thus, the liner weight may be regarded as parasitic. It would be desirable to eliminate this inner liner, if possible, without sacrificing or compromising the impermeability of the tank.

Another problem encountered in the manufacture of the presently available storage tank or vessel is the fact that components, such as fittings, are frequently connected to the tank and it would be desirable to connect these components from the inside thereof. Moreover, and in many cases, it is desirable to subdivide the internal chamber of the tank into one or more compartments. In addition, baffles are frequently included in the tank. However, most of the conventional commercially used processes for fabricating tanks do not allow for the formation of the tank in such manner that access to the interior can be obtained. This is particularly true if the tank access is of restricted diameter. Generally, the tank may either be formed of metal using conventional metal forming and welding techniques, or otherwise.

There have been several proposed pressure vessels formed of reinforced plastic composite materials for use in high altitude or in outer space environments. These tanks are frequently used for containment of fuel, oxidizers, propellants, including for example, hydrazine, and the like. Usually, these tanks are pressurized with a gas, as for example, helium or one more other gases, for driving of a propellant or other constituent in the vessel. Moreover, they typically remain pressurized until the propellant has been exhausted.

Most liners are formed of metals such as steel or titanium, although other materials are used, as well, in the formation of the liner. Helium and the other gases, whether or not reactive or inert, have a strong tendency to leak through many materials, and must be therefore well sealed within the pressure vessel. As a result, the reinforced plastic composite tanks heretofore produced almost necessarily included a liner for holding a fluid, such as a gas, under pressure without substantial leakage.

Although the metal liner carries a fraction of the induced pressure and other loads, the common use of metal liners in tanks of this type are usually detrimental to the overall tank design and also limits the performance of the tank as a result of strain incompatibility between composite fibers and the metal. In cases of this type, the tank performance is generally a function of the fatigue behavior of the liner and not the reinforcing outer shell of the tank. In some cases, plastic liners have been used. However, the weight of the plastic liner is almost totally parasitic in nature since it carries essentially no load. The function of the plastic liner is merely to serve as a shape upon which to wind an overwrap, such as an outer shell, and/or to serve as a barrier to gas or liquids and thus, the outer shell carries essentially all of the load.

It has also been found highly desirable to employ vanes and baffles in these pressurized vessels in order to prevent vortexing, which could result in an insufficient amount of, or an excess of propellant, for delivery of a fluid in the tank. It is also desirable, in many cases, to install fittings or other components on the tank. Moreover, it is preferable to install these fittings from the inside of the tank. However, when a pressure vessel is wound from a reinforced plastic composite material, access to the interior of the tank is generally difficult.

It is also important in the design of the tank to ensure that the materials of construction of the tank, and particularly that of the liner used in a tank, do not react with the gases or other fluids which are contained within the tank. This is particularly true where an oxidizing agent may be contained in the tank. In such cases, the oxidizing agent could be reactive with the materials of construction of the tank, resulting in decomposition of same.

It would be desirable to provide a reinforced composite pressure vessel which has the desired durability and strength where an inner liner in the tank effectively serves as a barrier to leakage of a fluid contained therein and which inner liner also can receive a substantial portion of any pressure induced load. Moreover, it would be desirable to provide a pressure vessel of the type stated in which baffles and other components such as fittings and the like could be incorporated in the tank which is formed of a reinforced plastic composite material.

### OBJECTS OF THE INVENTION

It is, therefore, one of the primary objects of the present invention to provide a reinforced plastic composite vessel capable of withstanding containment loads of pressurized fluid, and which uses a liner capable of receiving and carrying a pressure induced load withstanding containment loads in the vessel.

It is another object of the present invention to provide a pressure vessel of the type stated which is made from a reinforced plastic composite material, but which is also made without a weight imparting liner thereby enabling the vessel to possess reduced weight and which better lends itself to use in applications where weight is particularly critical, e.g., space vehicles and GNC vehicles.

It is a further object of the present invention to provide a reinforced plastic composite pressure vessel of the type stated which can be produced as a one-piece shell, separated for introduction of components into the ultimately formed tank and then rejoining to produce a solid leakage-free joint between the shell parts.

It is a further object of the present invention to provide a method of producing a reinforced plastic composite vessel by forming a complete shell serving as an inner liner and form upon which an outer shell can be provided and which is separated into component parts allowing for assembly of components into the vessel interior.

It is an additional object of the present invention to provide a method of producing a reinforced plastic composite vessel of the type stated in which a portion of the vessel is separated, providing access to an interior thereof for mounting of component parts therein and for reassembling the two sections of the vessel with a joinder ring therefor.

It is yet another salient object of the present invention to provide a method of the type stated, which can be performed at a relatively low cost and which is highly efficient in operation.

It is also an object of the present invention to provide a light weight, high performance tank constructed from materials which provide low weight and are capable of containment of pressurized fluids and which tank is relatively free of reactivity with components in a contained fluid.

With the above and other objects in view, my invention resides in the novel features of form, construction, arrangement, and combination of parts and components presently described and pointed out in the claims.

### BRIEF SUMMARY OF THE INVENTION

The present invention relates primarily to a vessel or tank of the type which can be used for containment of gases or liquids including for example, liquids such as various liquid fuels. The tank of the present invention may or may not include fittings and components used in or on the vessel. These components can be made from reinforced plastic composite materials, as for example, resin impregnated carbon, graphite, aramid, glass, etc., or other materials of construction.

The tank or vessel in the present invention is characterized by the fact that the tank is essentially formed of a reinforced plastic composite material which is relatively light in weight and which, along with an outer shell, carries a substantial portion of any pressure induced loads. The liner also is effective to be relatively impermeable to gases contained under pressure.

The tank of the invention can also be considered to be a two shell tank without any inner liner. The tank is comprised of an inner shell which, in addition to carrying load, also effectively functions as a mandrel for an outer shell to be formed, as hereinafter described, and together with the outer shell actually forms the pressure vessel. The inner shell is formed of a reinforced plastic composite material with a relatively minimal wall thickness. Nevertheless, this wall thickness is sufficient to be structurally stable during a separating of the inner shell and rejoining of the inner shell, also as hereinafter described. It is also sufficiently stable to enable overwinding of the outer shell on the inner shell in which the latter serves as an in-situ mandrel.

After the inner shell has been wound, or otherwise formed with a reinforced plastic composite material, it is then subjected to autoclaving to provide a high level of consolidation. In addition, this autoclaving also maximizes resistance to any fluid permeation, and particularly gas permeation.

The inner shell is typically formed with an elongate cylindrical tube-like construction having end caps integral therewith. Thus, the interior chamber formed by this inner shell is therefore effectively closed, except for end polar cap openings adapted to receive end fittings and the like. However, this interior chamber is generally not readily accessible for purposes of introducing fittings or baffles or like components therein.

The inner shell is then split perpendicularly to its longitudinal axis, that is radially across the tubular portion of the shell in order to form two half shell sections. In this way, immediate access can be obtained to the interior of the shell sections for mounting of fittings and other components which will be included in the tank.

After various fittings are located at the poles of the tank, and secured to the inner shell, other components such as baffles, barrier films and the like, can also be incorporated in the interior in the tank sections.

After all of the auxiliary components have been fitted into and mounted within the tank, the two half shell sections can then be brought together and permanently secured together. For this purpose, a uniquely tapered joining ring or so-called “joinder ring” is employed. Reinforcing material is also bonded to the edges of the inner shell section at the edges where the tubular portion of the inner shell was cut or sawed, to form reinforcing regions, in the nature of reinforcing rings adjacent to the open or cut ends thereof. These reinforcing areas are bonded and preferably integrally sealed in an autoclave operation to the inner walls of the inner shells. Thereafter, the reinforcing material may be machined to a suitable taper. This taper on the edges of each of the inner shell sections is used to reconnect the two shell sections together through the use of the joinder ring, which also has matching tapers machined in the outer edges thereof.

The taper on the ring and the taper on the edges of the two shells at the point of joinder ensures that adhesive is not removed as the two shell sections and the joinder ring are brought together and assembled. In this way, there will be a complete bonding operation. In addition, this tapering of the edges ensures that pressure is generated on the adhesive as the parts are assembled and cured.

At this point in the process, an outer shell may be formed over the inner shell. Typically, filament winding of fiber reinforcing composite material is used to form the outer shell. The thickness of this outer shell is determined by the total pressure and other loads which will be encountered in the ultimate pressure vessel as formed. Generally, this shell will carry a load in proportion to the thickness of the outer shell. The outer shell carries pressure induced tensile loads, but is not exposed to the gas on the inside of the tank. However, since the outer shell does not come into contact with any gas carried by the tank, it is actually not necessary to autoclave the outer shell. Nevertheless, the outer shell can also be autoclaved, if desirable, depending upon the circumstances of use.

It can be noted that the outer shell can actually become integral with the inner shell during the winding operation. For this rpose, if a thermoplastic resin was used, upon reheating of the inner shell with the outer shell applied thereto, a true integral formation will result. Nevertheless, in most pressure applications, the load always is applied to the interior shell forcing this interior shell into rigid contact with the outer shell. Moreover, and because of the unique process involved, there is no need for a liner with this tank.

This invention possesses many other advantages and has other purposes which may be made more clearly apparent from a consideration of the forms in which it may be embodied. These forms are shown in the drawings forming a part of and accompanying the present specification. They will now be described in detail for purposes of illustrating the general principles of the invention. However, it is to be understood that the following detailed description and the accompanying drawings are not be taken in a limiting sense.

### BRIEF DESCRIPTION OF THE DRAWINGS

Having thus described the invention in general terms, reference will now be made to the accompanying drawings in which:

FIG. 1 is a perspective view of a tank constructed in accordance with and embodying the present invention;

FIG. 2 is a side elevational view of an inner shell forming part of the tank of the invention and schematically showing a saw blade cutting the inner shell into a pair of shell sections;

FIG. 3 is a somewhat schematic side elevational view showing the formation of an inner shell on a mandrel;

FIG. 4 is a sectional view showing the inner shell on the mandrel when fully formed and before removal of the mandrel;

FIG. 5 is an exploded side elevational view showing the arrangement of the two shell sections with the annular reinforcing rings and the joinder ring;

FIG. 6 is an exploded sectional view showing the installation of a fitting in one end of one of the shell sections;

FIG. 7 is a sectional view, similar to FIG. 6, and showing a fitting fully connected to one of the shell sections;

FIG. 8 is a sectional view showing a modified form of fitting such as an end piece which may be installed in place of the fitting of FIG. 6;

FIG. 9 is an exploded sectional view showing the relationship and the initial location of the pieces when joining the two inner shell sections together, and including the two inner shell sections and a joinder ring;

FIG. 9a is an enlarged fragmentary sectional view showing the details of an end region of the joinder ring and a shell section;

FIG. 10 is a fragmentary sectional view, somewhat similar to FIG. 9 and showing a joinder ring secured to one of the shell sections with the other shell section, in a position to be secured thereto;

FIG. 11 is a sectional view, similar to FIGS. 5 and 9, and showing the arrangement of the joinder ring and the two shell sections when fully joined together;

FIG. 12 is a somewhat schematic side elevational view showing the initial stage of winding an outer shell about the inner shell;

FIG. 13 is a somewhat schematic side elevational view, similar to FIG. 12, and showing the winding of additional strands of composite material used in the formation of the outer shell;

FIG. 14 is a sectional view showing various layers forming part of the tank of the present invention; and

FIG. 15 is a schematic block diagram showing various steps in the method of the present invention.

### DETAILED DESCRIPTION OF A PREFERRED EMBODIMENT

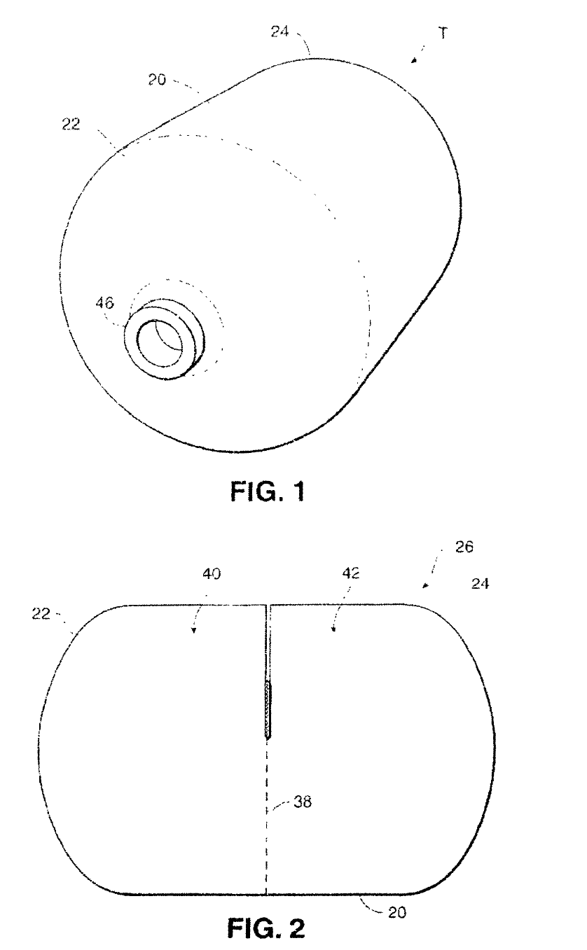

Referring now in more detail and by reference characters to the drawings, which illustrate practical embodiments of the present invention, T designates a storage vessel or tank constructed in accordance with the present invention. In this particular embodiment, as illustrated, the tank is elongate and has a cylindrically shaped side wall 20, as well as semi-ellipsoidal or similar shaped end-piece, or so-called “domes”, 22 and 24 in the manner as best shown in FIGS. 1-3 of the drawings. It should be understood, however, that any shape of tank and any size of tank could be constructed in accordance with the method of the present invention.

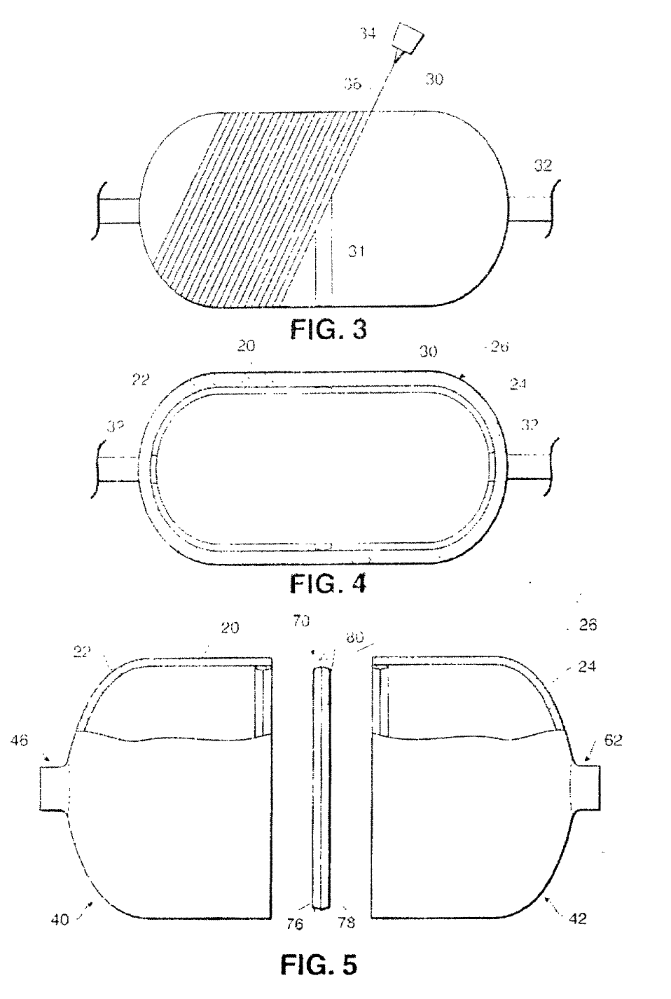

The tank T does not include an inner liner, as aforesaid, but does include an inner shell and an outer shell, in a manner to be hereinafter described in more detail. An inner shell 26 forming part of the tank is also shown in FIGS. 2 and 3 of the drawings. The inner shell 26 may be formed in any of a variety of ways, although it is preferably formed of a reinforced plastic composite material. FIGS. 4 and 5 more fully illustrate the formation of the inner shell is one embodiment of the invention.

A mandrel 30 is provided and mounted on a mandrel shaft 32 for rotation thereby. The mandrel and mandrel shaft 32 are located on a conventional winding machine capable of winding reinforced composite strands upon the mandrel 30. In this case, the winding machine (not shown) would include a winding head 34 for winding strands 36 about the mandrel 30. Conventional winding patterns would be employed for the actual winding of the various strands and would potentially include helically wound strands as shown, circumferential strands and longitudinal strands, as may be desired to form a balanced laminate. These strands would be resin impregnated with a suitable curable resin, including any of a number of conventional thermosetting resins or thermoplastic resins.

It is also possible to use pre-impregnated reinforcing filaments. These reinforcing filaments could be pre-impregnated in any conventional manner and wound upon a mold or mandrel 30 in that pre-impregnated form.

The filament containing material may be any continuous natural or synthetic filament which is capable at some stage of being elastically deformed to allow conformance to a desired shape. Moreover, the filament material may be applied in the nature of a fabric or in other forms. The filament may also be applied in discrete lengths of filament material. Some of those filament materials which can be used include boron, fiberglass, carbon, graphite, as well as other known filament materials.

At some point in the process, the resins which are impregnated into the filament containing material should be sufficiently liquid to permit wetting and encapsulation of the filament. They should also be capable of achieving a rigid state through polymerization to produce a two-phase composite material. Some suitable thermosetting resins which can be employed include, epoxy resins, bismalemides, vinyl esters, phenolics, and the like. Some thermoplastic materials which can be used include polypropylene, polycarbonate, etc.

FIG. 3 shows the mandrel 30 with the inner shell 26 being formed thereon in a filament winding operation. It can be observed that helical wound strands are being located on the surface of the mandrel and which would thereafter be followed by other strands including, for example, helical strands wound in an opposite direction, circumferential strands and possibly longitudinal strands. The mandrel 30 is also provided with an annular recess 31 extending about the side wall of the mandrel 30. This recess is designed to facilitate the sawing or splitting of the inner shell.

In order to remove the mandrel and to install internal components within the inner shell, the inner shell is split in the region defined by the groove 31, preferably by conventional sawing techniques or the like. FIG. 2 illustrates the inner shell 26 being split along a split line 38 into a pair of shell halves or shell sections 40 and 42. In this case, it is not necessary to divide the two shell sections 40 and 42 into half shells. Rather, the split line and the groove 31 can be located anywhere, although preferably in the cylindrical side wall section 20. It is only important, in this regard, that access be had to the interior of the tank in order to remove the mandrel and provide access for installation of components, as hereinafter described.

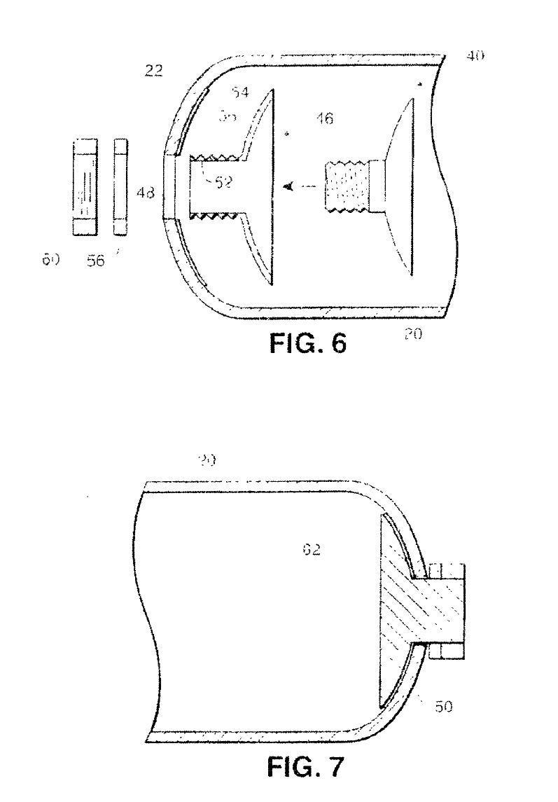

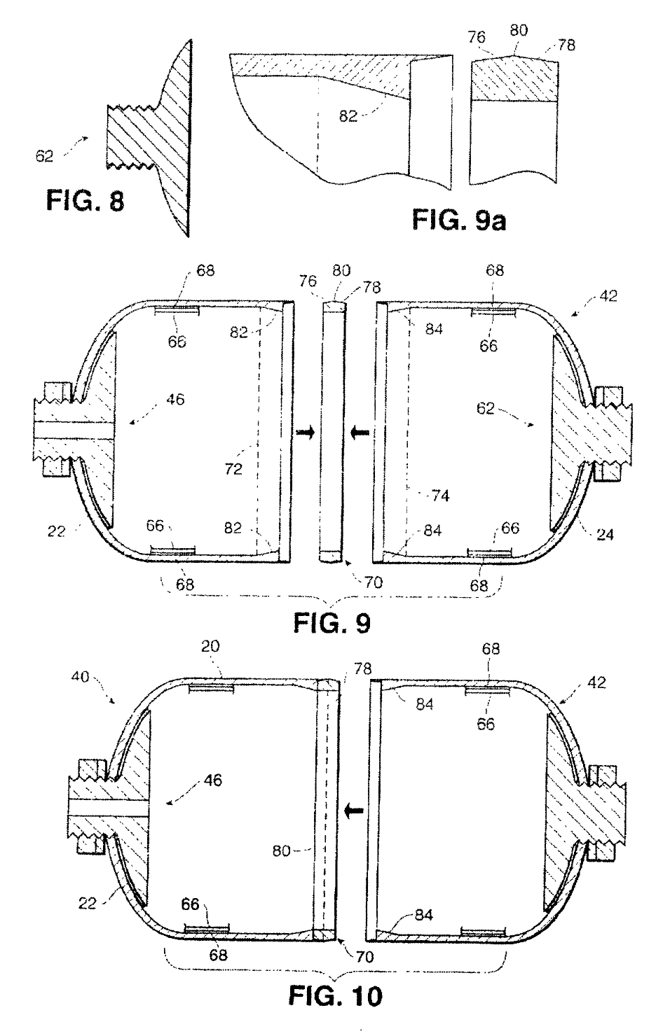

After the inner shell 26 has been split into the shell sections 40 and 42, end fittings can be applied to the shell sections. FIG. 6 more fully illustrates an end fitting being attached to the shell section 40. In this case, it can be observed that the shell section 40, and for that matter the shell section 42, is formed with an end cap opening 48 in the generally semi-ellipsoidal dome 22 forming part of the shell section 40. In like manner, a similar opening 48 would exist in the opposite ellipsoidal end dome 24 forming part of the shell section 42. The fitting 46 is typically provided with an outwardly extending tubular stub 52 and a flaring somewhat arcuately shaped end wall engagement section 54.

It can be observed that the end wall engagement section 54 is rigidly secured to the inner surface of the semi-ellipsoidal end wall 50 through an epoxy or similar adhesive 56. Any means for securement of the fitting 46 may be used for this purpose. It is important, however, for the fitting to form a fluid tight seal with the interior surface of the semi-ellipsoidal end wall 50. If desired, a washer 58 and a locking nut 60 can be secured to the end of the tubular section 52 of the fitting 46.

In place of the fitting 46, it is possible to use a fitting 62 of the type more fully illustrated in FIGS. 7 and 9 of the drawings. In this case, it can be observed that the fitting 62 would fit at the end dome 22 or end dome 24 and extend through the associated end dome opening. In this case, the fitting 62 actually serves as a type of plug to completely close the opening 48 at one end of the inner shell 26. It should be understood, however, that any type of fitting can be used for this purpose. FIG. 7 illustrates the arrangement of this fitting 62 fitted within the opening 48 of the hemispherical end wall 50.

It is also possible to form a hub on the portion of the hemispherical end wall surrounding the opening 48. Again, any size or type of hub can be formed on the shell sections as may be desired.

As indicated previously, it is frequently important to incorporate baffles or other flow regulating members on the interior chamber of the tank T. Although not illustrated, in view of the fact that the sections 40 and 42 have open ends, it is possible to incorporate any type of component to be mounted on the inside of the vessel thus formed.

After the various components have been fully installed in the interior of the shell sections 40 and 42, these sections can then be abutted and secured together. However, prior to joining of the two shell sections, it may also be desirable to add a barrier film to the interior surface of the inner shell 26. The barrier film, or coating, is typically chosen for its resistance to fluid permeation in addition to its ability to resist the physical or chemical effects of the fluid contained in the finished vessel. One such barrier film 66 is shown as being applied to the interior surfaces of each of the inner shell sections 40 and 42. Again, only a small section of the barrier film has been illustrated in the shell sections in order to show the use thereof and to avoid obscuring the illustrations thereof. However, it should be understood that the barrier film 66 would be applied to the entire interior surface of the inner wall of each of the shell sections 40 and 42.

The barrier film 66 would preferably be applied by means of a suitable adhesive, such as an adhesive layer 68. Again, any type of adhesive which will securely hold the barrier film against the interior surface of the inner shell can be used. In some situations, the adhesive could actually function as the barrier film.

FIGS. 3 and 9-11 more fully illustrate the attachment of the two shell sections 40 and 42. For purposes of attaching two shell sections, a joinder ring 70 of the type illustrated in FIGS. 3 and 9, is employed. For purposes of joining the two end sections 40 and 42, each of these end sections are provided with reinforcing regions 72 and 74. These reinforcing regions actually form rings of reinforcing material and are therefore sometimes referred to herein as reinforcing rings. These reinforcing rings are designed to cooperate with the joinder ring 70 and enable to the shell sections to be tightly fitted together as a single unitary structure.

The joinder ring 70 is also preferably formed of a reinforced plastic composite material. Moreover, the outer surface of the ring 70 is provided with a pair of reversely tapered surfaces 76 and 78. These tapered surfaces taper inwardly and radially outwardly to a cylindrically extending peak 80 which forms a ring line around the center of the ring 70. Moreover, each of the reinforcing regions 72 and 74 are provided with circumferentially extending tapered surfaces 82 and 84, which respectively match the tapered surfaces 76 and 78 on the joinder ring 70.

The angle of taper of the tapered surfaces 76 and 78 on the joinder ring is relatively small in the range, typically of about 2° to about 10°. In like manner, the angle of taper on the reinforcing regions 72 and 74 and the tapered surfaces 82 and 84, respectively thereof, matches the angle of taper on the joinder ring, also in the range of roughly 2° to about 10°. This angle can vary, although the range specified above is the most preferred.

In accordance with the above outlined construction, it can be observed, particularly by reference to FIG. 10, that when the joinder ring 70 is located at the open end of the shell section 40, the tapered surface 76 on the joinder ring 70 mates with and physically engages the tapered surface 82 in the reinforcing region 72. Moreover, these surfaces are so perfectly matched that when an adhesive is used between the joinder ring and the reinforcing regions, the joinder ring becomes physically and permanently bonded to the interior of the shell section.

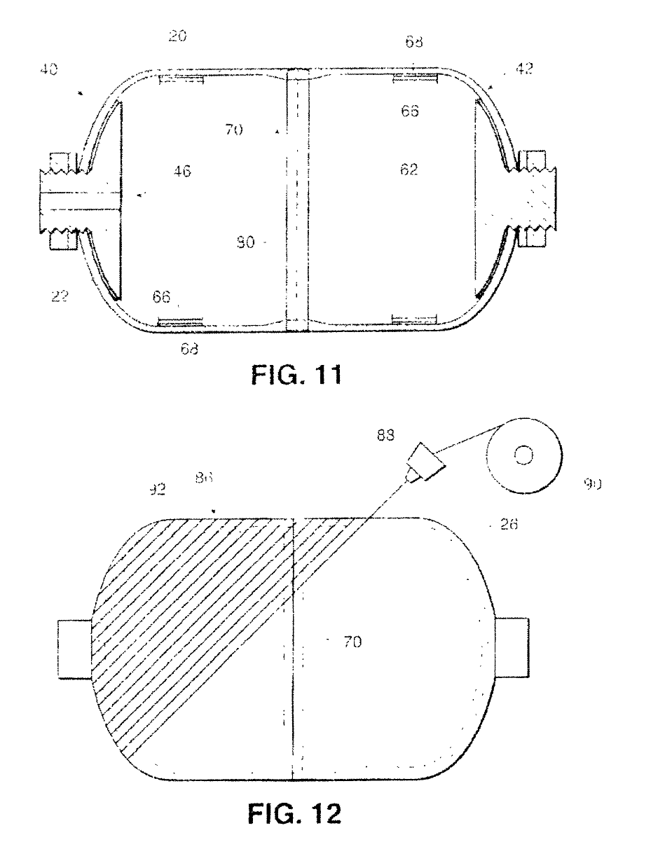

FIG. 10 illustrates the joinder ring 70 being physically bonded to the shell section 40 and also shows the shell section 42 in a position to be subsequently attached to the joinder ring 70. FIG. 11, however, illustrates the two shell sections both secured to the joinder ring 70. It can also be seen that the peak 80 of the two surfaces 76 and 78 actually mates with the split line between the two shell sections 40 and 42. In this way, the two shell sections will actually physically abut at the edges adjacent the joinder ring 70 and will become physically bonded to the joinder ring 70. In accordance with this construction, a complete fluid tight seal is achieved.

The reinforcing rings which are formed on the two shell sections are usually formed of reinforcing material and cured to the inner shell sections. They are then machined with the desired tapered surfaces to form a double lap joint. The dimensions of the reinforcing regions and the joinder ring are selected so as to provide load transfer at that joint. The joinder ring has tapered surfaces and the reinforcing regions have correspondingly tapered surfaces which typically range between 2° to 10° as aforesaid. This insures that loads are transferred in shear with little transverse tension. The joinder ring and the reinforcing regions provide a joint thickness of typically 0.008 to 0.012 inch after applying the adhesive at the joint.

After the inner shell has been completely reassembled, substantially as shown in FIG. 11, it can be observed that this shell is actually capable of functioning as a vessel although perhaps without the full load bearing capacity of the tank T. In this respect, the inner shell 26 includes all of the components necessary to function as a pressure vessel although without the total strength to withstand the design internal pressure loading.

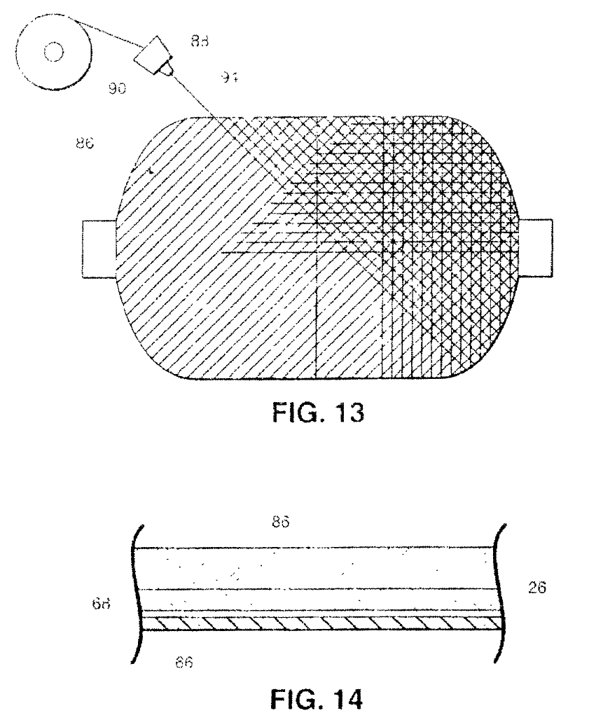

FIGS. 12 and 13 illustrate the formation of an outer shell 86 being formed over the inner shell 26. In this case, it can be observed that the outer shell 86 is being formed by a filament winding process in which the inner shell is mounted on a shaft (not shown) of a filament winding machine. A winding head 88 which receives strands of a filament containing material from a spool 90 applies the strands to the inner shell 26. In FIG. 13, it can be observed that helical windings 92 are first being applied to the inner shell 26. Thereafter, it can be seen that circumferential windings and longitudinal windings had been applied to the inner shell which is being followed by helical windings 94 applied in the opposite direction to provide a balanced ply. Again, any desirable winding pattern can be used for this purpose.

After the filament containing reinforcing material has been fully wound about the inner shell, the resin impregnated therein can be hardened. As this occurs, the outer shell actually becomes physically or chemically bound to that inner shell. Depending on selection of materials and production conditions it is possible to cause the outer shell actually to become an integral member with the inner shell to form a single layer during the curing of the resin. However, the inner shell, as previously described, is sufficient to prevent any leakage of any gas which may be contained therein. The inner shell joint, formed by the joining ring 70, and the reinforcing rings 82 and 84, impart the required strength and stiffness to carry a proportional share of the pressure induced loads.

FIG. 14 illustrates the various layers which form part of the shell and include the outer shell 86 and the inner shell 26 as well as the adhesive 68 and the barrier film 66. However, and as indicated previously, the two shells 86 and 26 actually become integrally bonded together to form a single shell.

The barrier lining or film is selected to minimize fluid permeation and resist the chemical or physical effects of the contained fluid. Moreover, it is likely to be used when the tank will experience microcracking as a result of internal pressure and inertially induced loads. It is possible for some microcracking to result from high strain concentrations between the reinforcing filaments. In order to prevent high strain concentrations from being transmitted to the film, with the concomitant result of localized failures, the barrier film is preferably bonded to the inner wall with a non-rigid adhesive. The thicknesses of the inner and outer shell will be determined by the internal pressure to be contained within the tank and other loads which may be imposed thereon. However, inasmuch as the outer shell always receives pressure induced tensile loads and is not exposed to the direct gas pressure, the curing of the outer shell does not have to take place in an autoclave.

The tank construction of the invention allows for the use of materials which provide high structural efficiency and allows for a low weight tank which is especially valuable for spacecraft launch vehicles and satellites. The use of the dual shells allows for the inner shell to carry loading in proportion to its stiffness and strength. The outer shell generally being thicker and stiffer will carry a greater portion of any induced loads. In this way, the inner shell does not become a parasitic shell, but rather contributes to the load carrying capabilities of the structure.

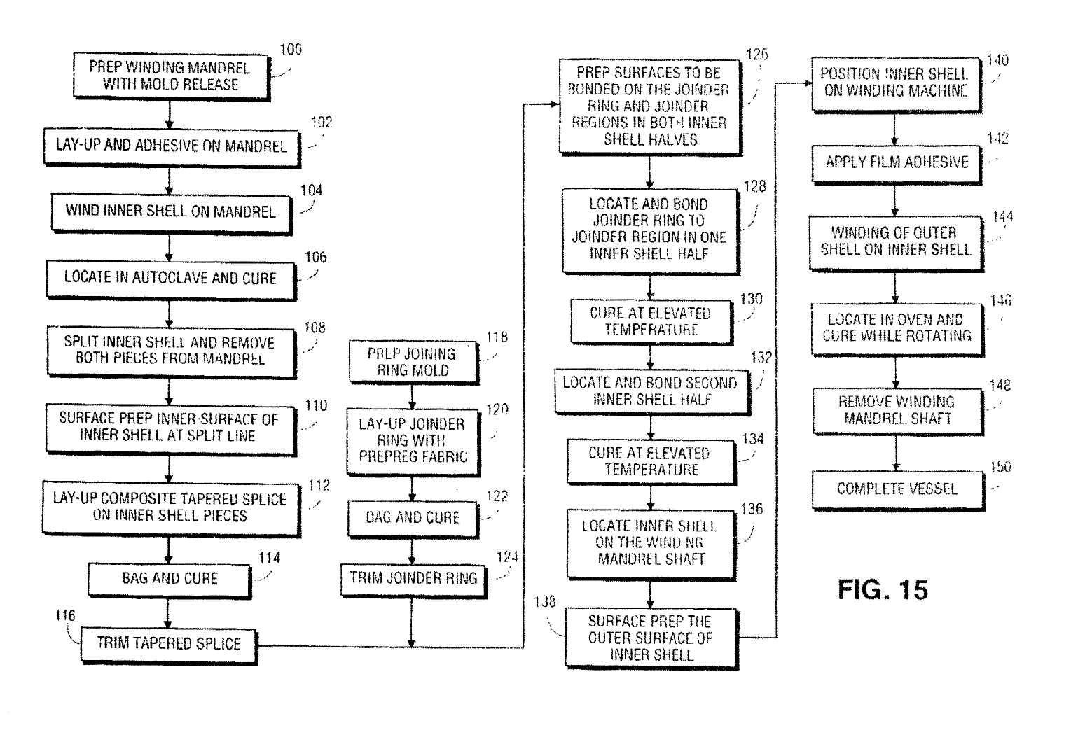

The method of the present invention has generally been described in connection with the description of the tank T and the components forming a part thereof. However, FIG. 15 more fully illustrates the various method steps which take place in the performance of this method of making a tank of the invention.

Referring to FIG. 15, and prior to the actual winding of composite material on a mandrel to form the inner shell, the mandrel is prepared by applying a mold release at step 100 which is followed by a lay-up of adhesive on the mandrel at step 102. In this case, resin could actually be pre-impregnated in the filament containing material which is wound on the mandrel to form the inner shell. Step 104 shows winding of filament material on the mandrel in order to form the inner shell. Again, any of a number of desired winding patterns can be used for this purpose. After the winding process, the resin impregnated in the composite material is cured in order to provide a rigid inner shell. In this respect, and inasmuch as the tank is designed without a liner, the curing is actually performed in an autoclave and preferably, the curing occurs at a temperature of about 250-350° F., at step 106. After complete formation of the shell in a rigid form, the shell is then split at step 108 so that both of the shell sections thus formed can be removed from the mandrel.

The individual shell sections which are thus formed are then prepared at the split line for the formation of reinforcing rings at step 110. Thereafter, the reinforcing rings are formed at step 112 which describes the composite lay-up for the tapered rings at the edge of inner shell sections. In actuality, this is the point in the process where the reinforcing rings are formed at the edges of the shells. Thereafter, and at step 114, the reinforcing rings on the shell sections are cured, again preferably at a temperature of about 250-350° F. In order to achieve a smooth tapered region on the reinforcing rings at the edges of each of the shells, these rings are trimmed and machined at step 116.

Steps 118 through 124, as hereinafter described, deal with the formation of the joinder ring used in the invention. In this case, a mold is used and is prepared for formation of the joinder ring in step 118. In step 120, the joinder ring is laid-up with pre-impregnated reinforced plastic composite fabric. After the ring has been properly laid-up, it is bagged and cured at step 122. At this point, this hardened ring is trimmed and possibly machined if required, at step 124, to thereby result in the joinder ring.

At this point in the process, the two shell sections are secured together with the joinder ring. In this case, the surfaces to be bonded to the joinder ring on both of the shell sections are prepared, as for example, with bonding material at step 126. The joinder ring is then located and bonded to one of the shell sections in step 128. The joinder ring and the one shell section which are then abutted together are cured at an elevated temperature at step 130. This is followed by locating and bonding the other shell section at step 132. Finally, the second shell section is secured to the first shell section and the joinder ring by curing at an elevated temperature at step 134.

At this point in the process, the inner shell has been completely formed. The invention therefore provides for the formation of the outer shell over the inner shell. In this case, the inner shell is then mounted on a mandrel winding shaft at step 136. The outer surface of the inner shell is prepared, as for example, with a binding material at step 138. The inner shell is then located on a winding machine at step 140 where a film adhesive is applied at step 142, followed by winding of the outer shell at step 144. When the desired winding pattern to form the outer shell has been obtained, the entire assembly is located in an oven at step 146 and rotated while being cured. The final product is then removed from the mandrel shaft at step 148 resulting in the complete vessel at step 150.

Thus there has been illustrated and described a unique and novel low weight, high performance composite vessel and method of making same and which thereby fulfills the objects and advantages which have been sought therefor. It should be understood that many changes, modifications, variations and other uses and applications which will become apparent to those skilled in the art after considering the specification and the accompanying drawings. Therefore, any and all such changes, modifications, variations and other uses and applications which do not depart from the spirit and scope of the invention are deemed to be covered by the invention.

Having thus described the invention, what I desire to claim and secure by letters patent is:

1. A reinforced plastic composite pressure vessel for containment of fluids which may be under pressure, said pressure vessel comprising:
a) a pair of shell sections made from a reinforced plastic composite material with each having a cylindrical side wall and one end wall thereon along with an open opposite end;
b) a reinforcing region adjacent and surrounding the open end of each of said shell sections and which reinforcing regions cooperate to enable said shell sections to be joined together and thereby form a unitary reinforced plastic composite pressure vessel;
c) said shell sections having opposing and matching ends which are adapted to be abutted together to form a complete shell; and
d) a joinder ring fitted within the open ends of each of said shell sections when said shell sections are brought together in abutting relationship and which ring engages the reinforcing regions at the open ends of each of said shell sections and thereby allows for complete sealing attachment of the two shell sections together to form said vessel.

2. The reinforced plastic composite vessel for containment of fluids of claim 1 further characterized in that said shell sections together comprise an inner shell wall of the vessel and that an outer shell wall is disposed about said inner shell wall and is secured thereto.

3. The reinforced plastic composite vessel for containment of fluids of claim 3 further characterized in that said outer shell wall is formed by applying of filament containing reinforcing material about said inner shell.

4. The reinforced plastic composite vessel for containment of fluids of claim 1 further characterized in that said joinder ring has surfaces which match and engage surfaces of said reinforcing regions and enable said shell sections to be joined together to thereby form said vessel.

5. The reinforced plastic composite vessel for containment of fluids of claim 1 further characterized in that said reinforcing regions in each of said shell sections have tapered surfaces and the joinder ring has similarly tapered surfaces which match and engage the tapered surfaces of each of said shell sections and lie in close fitting contact therewith when the two shell sections are brought together in abutting engagement.

6. The reinforced plastic composite vessel for containment of fluids of claim 1 further characterized in that said joinder ring is formed of a reinforced plastic composite material.

7. The reinforced plastic composite vessel for containment of fluids of claim 3 further characterized in that said outer shell is integrally bound to said inner shell.

8. A relatively low weight and high performance, liner-less pressure vessel capable of retaining fluid under pressure in adverse environmental conditions, said vessel comprising:
a) a preformed unitary vessel having a side wall and end members integral therewith to thereby form an interior chamber, and which vessel is divided into a pair of separate and engageable vessel shell sections;
b) end fittings cured to interior surfaces of the end members of said vessel and being integral therewith;
c) a joinder ring located within each of said shell sections when brought together and being secured to said shell sections to form a complete unitary vessel.

9. The relatively low weight, high performance and liner-less pressure vessel of claim 8 further characterized in that said shell sections each comprise a cylindrical reinforcing ring at the open ends of the said shell sections and having mating surfaces thereon; and said joinder ring also having mating surfaces which match the mating surfaces of said reinforcing rings.

10. The relatively low weight, high performance and liner-less pressure vessel of claim 8 further characterized in that said vessel has an outer shell which is secured to and disposed thereabout and completely encloses same.

11. The relatively low weight, high performance and liner-less pressure vessel of claim 10 further characterized in that said outer shell is filament wound on the vessel and secured thereto.

12. A high performance liner-less pressure vessel formed primarily of fiber reinforced plastic composite material and comprising:
a) a fully cured filament wound reinforced plastic composite inner shell formed of a relatively minimal thickness but of a thickness sufficient to carry a portion of an induced pressure load in said vessel;
b) a filament wound reinforced plastic composite outer shell which is filament wound around said inner shell and completely covers said inner shell, said outer shell having a thickness to carry a substantial portion of any induced pressure load;
c) said inner shell being fully bonded to said outer shell forming a shell composite with a cylindrical side wall and end walls thereon;
d) an open port formed in each of said end walls; and
e) end fittings secured to the interior and exterior of said composite shell and extending outwardly therefrom, said end fittings being completely sealed against the interior surface of said inner shell in regions surrounding the ports at said end walls.

13. A high performance linerless pressure vessel formed primarily of fiber reinforced plastic composite material of claim 12, further characterized in that said inner shell is comprised of two sections which are joined together by an interior joinder ring, and said joinder ring has surfaces which match and engage surfaces of said shell sections and enable said shell sections to be joined together.

14. The high performance liner-less pressure vessel formed primarily of fiber reinforced plastic composite material of claim 13 further characterized in that said inner shell is integrally bonded to said outer shell and together form a unitary shell.

15. The high performance liner-less pressure vessel formed primarily of fiber reinforced plastic composite material of claim 13 further characterized in that a barrier film is secured to and substantially covers the full inner surface of the inner shell.

16. The high performance liner-less pressure vessel formed primarily of fiber reinforced plastic composite material of claim 13 further characterized in that said cylindrical side wall has a split line on the interior thereof.

17. A method of making a liner-less reinforced plastic composite pressure vessel, said method comprising:
a) forming a reinforced plastic composite inner shell of said vessel and which is comprised of a side wall and a pair of end domes;
b) separating said inner shell into a pair of shell sections;
c) installing interior components in said shell sections;
d) rejoining said shell sections at the region of separation to form a unitary inner shell; and
e) producing an outer shell about said inner shell and which outer shell constitutes a load bearing shell.

18. The method of making a liner-less reinforced plastic composite pressure vessel of claim 17 further characterized in that said method comprises winding fiber containing reinforcing material about said inner shell in order to produce said outer shell thereon.

19. The method of making a liner-less reinforced plastic composite pressure vessel of claim 17 further characterized in that said method comprises joining said shell sections together with a joinder ring therefor.

20. The method of making a liner-less reinforced plastic composite pressure vessel of claim 17 further characterized in that said shell sections have inner surfaces adapted to match the joinder ring and which allows the joinder ring to become permanently bonded to each of the shell sections.

21. The method of making a liner-less reinforced plastic composite pressure vessel of claim 17 further characterized in that the method comprises installing a barrier film around the interior surface of said inner shell.

22. The method of making a liner-less reinforced plastic composite pressure vessel of claim 17 further characterized in that said method comprises installing end fittings on each of said end walls from the interior of said inner shell, and which become permanently bonded to said inner shell.

23. The method of making a liner-less reinforced plastic composite pressure vessel of claim 17 further characterized in that an outer shell is wound about said inner shell and completely covers and encloses said inner shell, said outer shell carrying a substantial portion of any pressure load from containment of fluid therein.

24. A method of making a liner-less reinforced plastic composite pressure vessel, said method comprising:
a) forming a reinforced plastic composite inner shell of said vessel and which is comprised of a side wall and a pair of end walls;
b) separating said inner shell into a pair of shell sections, with each being an open end opposite the end wall of that section;
c) providing a joinder ring at the interior surface of each of said shell sections when abutted together at the open ends thereof and which allows for securement of the said shell sections together to thereby form a unitary vessel, said joinder ring having surfaces which mate with surfaces on said shell sections adjacent the open ends; and
d) permanently bonding said ring to said shell sections to thereby form a unitary shell.

25. A method of making a liner-less reinforced plastic composite pressure vessel of claim 24 further characterized in that the step of bonding the joinder ring to the two shell sections comprises joining of tapered edges on said ring to tapered reinforcing areas adjacent the open ends of said shell sections.

26. A method of making a liner-less reinforced plastic composite pressure vessel of claim 24 further characterized in that said method comprises causing the joinder ring and the two shell sections when assembled together to provide a bonded reinforced plastic composite structure.

27. A method of making a liner-less reinforced plastic composite pressure vessel of claim 24 further characterized in that said method comprises installing certain vessel components in the interior of said vessel before joining the two shell sections together.

28. A method of making a liner-less reinforced plastic composite pressure vessel adapted for high altitude or outer space use of claim 24 further characterized in that said method comprises over wrapping said assembled unitary shell with additional reinforced plastic composite material.
